(19) United States
(12) Patent Application Publication
(10) Pub. No.: US 2015/0073754 A1
(43) Pub. Date: Mar. 12, 2015

(54) METHOD AND SYSTEM FOR CALCULATING INDICES FOR DIABETES CONTROL

(71) Applicant: QUATTRO FOLIA OY, Espoo (FI)

(72) Inventors: Harri Okkonen, Espoo (FI); Antti Kokkinen, Espoo (FI); Ari Sinisalo, Helsinki (FI); Markku Saraheimo, Helsinki (FI)

(73) Assignee: QUATTRO FOLIA OY, Espoo (FI)

(21) Appl. No.: 14/020,933

(22) Filed: Sep. 9, 2013

(51) Int. Cl. G06F 19/00

(52) U.S. Cl. CPC G06F 19/3431
USPC 703/2

(57) ABSTRACT

The invention provides method and system for calculating indices for diabetes control. The method and system involves collecting a plurality of blood glucose (BG) data of a subject and calculating a Blood Glucose Control Index (BGCI) value and a Severe Hypoglycemia Risk Index (SHRI) value based on parameters calculated using the plurality of BG data. The BGCI and SHRI values reflects a current state of diabetes of the subject. Further, the BGCI and SHRI values provides an indication if the subject may face a secondary complication associated with diabetes, such as, severe hypoglycemia in the future.

### FIELD OF THE INVENTION

The invention generally relates to the field of blood glucose monitoring, and more specifically, to a method and system for calculating indices for diabetes control.

### BACKGROUND OF THE INVENTION

Individuals with diabetes have to control their blood glucose level to avoid a risk of hyperglycemia or hypoglycemia. Recent developments in the area of Self Monitored Blood Glucose (SMBG) systems have assisted diabetic patients in adjusting the intake of insulin and control blood glucose levels on their own. Patients using the SMBG systems need to adjust the insulin dosages based on one or more lifestyle factors such as, but not limited to, frequency of food intake, food intake timings, type of food, physical activity, stress and other medication being taken. Further, the patients need to adjust insulin dosages based on blood glucose values recorded manually during a day. The patients may consult a physician in order to arrive at an acceptable level of insulin dosage. There may be inaccuracies in the aforementioned procedure and there may be a risk of the patient contracting at least one secondary complication arising due to inaccurate dosage of insulin.

Inaccurate dosage of insulin may lead to excessive blood sugar (e.g. due to the patient injecting too little insulin) and the patient becoming hyperglycemic while a low blood sugar (e.g. due to the patient injecting too much insulin) may cause the patient to become hypoglycemic. In particular, excessive levels of sugar in the blood result in sugar combining with protein to form glycosylated protein. Glycosylated proteins (e.g. HbA_{1c} in hemoglobin) are substantially insoluble and lead to thickening of the walls of veins and myelination of nerves. An HbA_{1c} level reflects the effectiveness of blood glucose treatment over the 6-8 week period preceding the HbA_{1c} measurement. Typically, a range of 6%-7% of HbA_{1c} in the blood of a diabetic patient is a good indication that the dosage is effective and the risk of secondary problems related to HbA_{1c} is low. Taking only HbA_{1c} level as the risk indicator may not always provide accurate results.

Therefore, there is a need for calculating indices for diabetes control based on the blood glucose values and HbA_{1c} values so that the patients can regulate the insulin dosage effectively.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a flow diagram of a method for calculating a Blood Glucose Control Index (BGCI) based on a plurality of Blood Glucose (BG) data of a subject, in accordance with an embodiment of the invention.

FIG. 2 illustrates an exemplary graph representing a statistical model associated with the risk of secondary complications arising from diabetes as a function of HbA_{1c}.

FIG. 3 illustrates an exemplary graph representing risk curves of diabetic patients with equal average HbA_{1c} but a variation in a standard deviation of the HbA_{1c} (Std_HbA_{1c}).

FIG. 4 illustrates a flow diagram of a method for calculating the Severe Hypoglycemia Risk Index (SHRI) based on the plurality of Blood Glucose (BG) data of the subject, in accordance with an embodiment of the invention.

FIG. 5 illustrates a block diagram of a system for calculating the Blood Glucose Control Index (BGCI) and the Severe Hypoglycemia Risk Index (SHRI), in accordance with an embodiment of the invention.

FIG. 6 illustrates a block diagram of an indicator which is displayed on a display, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for calculating indices for diabetes control. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods and system for calculating indices for diabetes control. The method involves collecting a plurality blood glucose (BG) data of a subject. Further, the method involves calculation of one or more parameters based on the plurality of BG data such as, but not limited to, a HbA_{1c} estimate, a standard deviation of the plurality of BG data and a percentage of plurality of BG data above/below a threshold value. Thereafter, a Blood Glucose Control Index (BGCI) and a Severe Hypoglycemia Risk Index (SHRI) are calculated based on the one or more parameters calculated using the plurality of BG data. The BGCI and SHRI reflects a current state of diabetes of the subject and provides an indication if there is a chance of the subject contracting a diabetes related complication, such as, but not limited to, severe hypoglycemia in the future.

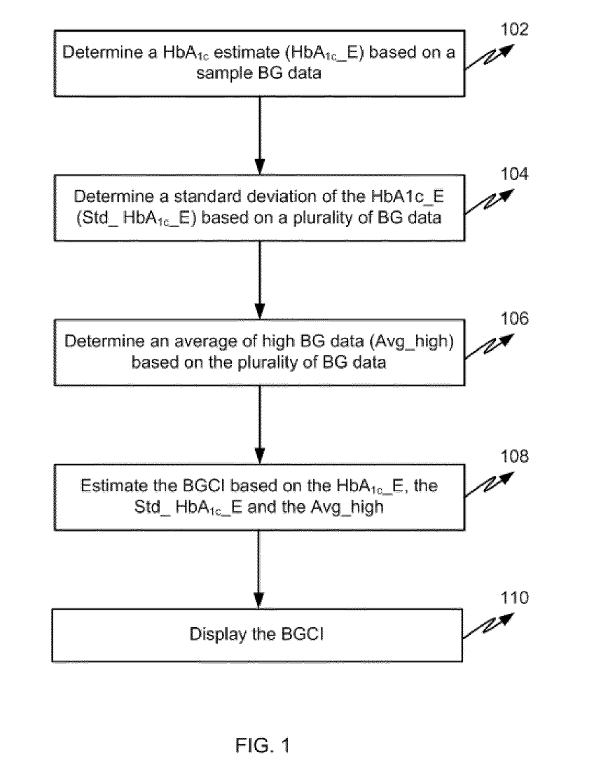

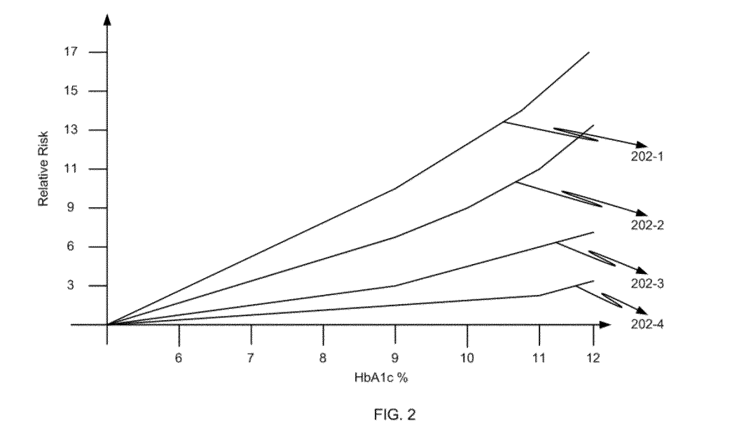

Reference will now be made to FIG. 1, which illustrates a flow diagram of a method for calculating a Blood Glucose Control Index (BGCI) based on a plurality of Blood Glucose (BG) data of a subject, in accordance with an embodiment of the invention. The BGCI is an indicator of a probability of contracting secondary complications arising from diabetes. The secondary complications are, for example, retinopathy, nephropathy, neuropathy and microalbuminuria arising due to diabetes. An exemplary graph representing a statistical model associated with the risk of secondary complications arising from diabetes as a function of HbA_{1c} is shown in FIG. 2. Risk curves 202-1 (retinopathy), 202-2 (nephropathy), 202-3 (neuropathy) and 202-4 (microalbuminuria) represent the risk of secondary complications arising from diabetes as a function of HbA_{1c}. BGCI is based on the values of short term HbA_{1c} and short term BG data, thereby providing the subject with an indication of a potential risk of contracting secondary complications. In an exemplary scenario, an increase in the BGCI value, which implies an increase in values of at least one of, a short term HbA_{1c} value and a short term BG data, indicates an increased risk of contracting secondary complications even though long term HbA_{1c} value remains unchanged. Alternatively, the diabetes control of an individual is very stable if the BGCI value is very close to the HbA_{1c} value, which implies minimum variation in HbA_{1c} values and the plurality BG data. In case the plurality of BG data varies excessively, the Std_HbA_{1c} will increase along with the Avg_High thereby resulting in a higher BGCI value. A higher BGCI value indicates a higher risk of contracting secondary complications. In another exemplary scenario, two diabetics may have an identical long term HbA_{1c} values but different BGCI values. In such a case, a diabetic with higher BGCI has a higher risk of contracting secondary complications than a diabetic with a lower BGCI.

The plurality of BG data for calculating the BGCI for the subject can be collected using a Self Monitored Blood Glucose (SMBG) system or using other suitable systems and methods. The plurality of BG data includes a set of BG data of the subject collected over a first period of time and a sample BG data of the subject collected over a second period of time. In an embodiment, the set of BG data is collected prior to the sample BG data. The first period of time during which the set of BG data is collected is a follow-up period ranging from 14-28 days. In some embodiments, the first period of time is longer and is used to define statistical properties of the BG samples and generate parameters such as, continuous HbA_{1c} estimate and Avg_High. Further, the first period of time provides the information to generate statistical models to estimate the physiological occurrences that may take place in the future, in accordance with the state of the subject at the beginning of the follow-up period. The second period of time during which the sample BG data is collected can be a time period of 24 hours. In some embodiments, the second period of time is shorter and is used as a baseline to estimate a risk of hypoglycemia for the next 24 hours. Additionally, the second period of time provides a current state of the subject regarding BG values, insulin dosages, meals, activities, etc. In an exemplary instance, the sample BG data is collected every day before a stipulated time, for example, before 9.00 AM. In some embodiments, the second period of time can extend to a few days, for example, 3-4 days.

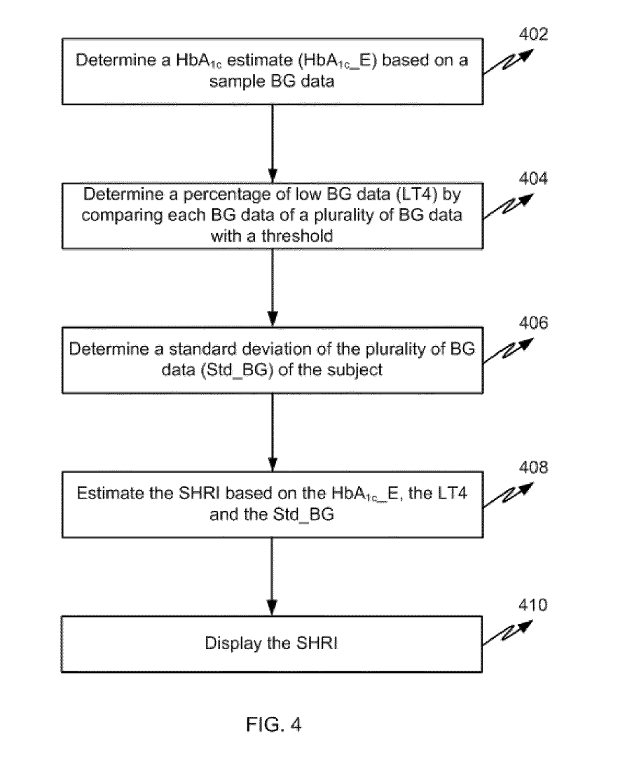

In an exemplary embodiment, various other data associated with daily activities of the subject may be recorded and utilized together with the BGCI and the SHRI (calculation of SHRI has been described in description of FIG. 4) for recommending an insulin dosage to the subject. For example, data associated with types of meals, timing of meals, type of physical activities, duration of physical activities and dosages of the additional medicines may be considered along with BGCI and SHRI. One or more health related measurements, such as, for example, Peak Expiratory Flow (PEF) measurements, blood pressure measurements, changes of voice and stress levels may also be used in addition to the BGCI and the SHRI values for recommending an insulin dosage to the subject. In general, any activity that may affect metabolism and thus blood glucose levels of the subject may be considered.

At step 102, an HbA_{1c} estimate (HbA_{1c—}E) is determined based on the sample BG data. In an exemplary embodiment, the HbA_{1c—}E is calculated using a stabilized HbA_{1c} estimation algorithm. For example, the HbA_{1c} estimation algorithm may be the HbA_{1c} estimation algorithm or similar to the algorithm explained in U.S. Pat. No. 6,421,633. The HbA_{1c} estimation algorithm can be based on a mathematical model to estimate a variation of the HbA_{1c} level relative to the plurality of BG data. In some embodiments, the HbA_{1c} estimation algorithm is stabilized by providing previous HbA_{1c} values of the subject.

At step 104, a standard deviation of the HbA_{1c—}E (Std_HbA_{1c—}E) is determined based on a plurality of HbA_{1c—}E values of the subject collected over a period of time. The Std_HbA_{1c—}E is calculated by first determining a mean HbA_{1c—}E value of the plurality of HbA_{1c—}E. Subsequently, the mean HbA_{1c—}E value is subtracted from each HbA_{1c—}E data of the plurality of HbA_{1c—}E data resulting in mean subtracted plurality of HbA_{1c—}E data. Thereafter, a square root of the average of mean subtracted plurality of HbA_{1c—}E data is taken for calculating the Std_HbA_{1c—}E.

At step 106, an average of high BG data (Avg_high) is determined based on the plurality of BG data. In an exemplary instance, the Avg_high includes an average of highest 10% of the plurality of BG data collected during the follow-up period. For example, if the plurality of BG data has 100 values, then Avg_high includes average of the top 10 values of the 100 values.

At step 108, the BGCI is calculated based on the HbA_{1c—}E, the Std_HbA_{1c—}E and the Avg_high.

In an exemplary embodiment, the BGCI is calculated using a formula as below,

BGCI=A×HbA_{1c}+f₁(Std_HbA_{1c—}E)+f₂(Avg_high)

wherein A is a decimal number and f₁ and f₂ are functions of Std_HbA_{1c—}E and Avg_high, respectively. In an exemplary implementation, the scaling factor A can be adjusted according to the population group based on the risk factors involved with the population group. For example, coefficient A can be set to 1 for Caucasian males whereas the coefficient A may be set to 0.8 for Afro-Caribbean males based on lower myocardial infarction risk factors associated with the respective population groups, as described in the article “Development of life-expectancy tables for people with type 2 diabetes” by Jose Leal et. Al published in European Heart Journal, 2009. In an exemplary embodiment, f₁ is defined as below:

f1=B×Std_HbA_{1c—}E,

wherein B is defined to provide statistical correlation between recognized risk of diabetes related secondary diseases and the variation of HbA_{1c} estimate. In an exemplary embodiment, f₂ is defined as below:

f₂=C×(Avg_high−6 mmol/l),

wherein C is defined to provide statistical correlation between recognized risk of diabetes related secondary diseases and the difference between Avg_high and blood glucose level of 6 mmol/l. In some embodiments, the value of blood glucose level can be changed based on the physiological parameters of the subject.

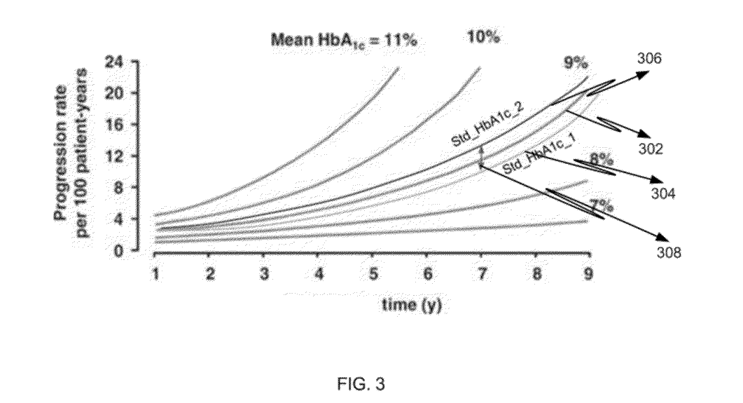

In some embodiments, the method calculates short term HbA_{1c} values (where HbA_{1c} values are calculated daily) which in turn are used to calculate a BGCI value. The BGCI value indicates a probability of contracting secondary complications in the future. FIG. 3 illustrates an exemplary graph representing risk curves of diabetic patients with equal average HbA_{1c} but a variation in the standard deviation of the HbA_{1c} (Std_HbA_{1c}). The curve 302 represents an average risk curve for retinopathy based on a variation of HbA_{1c}. Curve 304 represents a risk curve of a subject with an average HbA_{1c} of 9% but a lower Std_HbA_{1c}, hence a lower risk of contracting retinopathy in the future. On the other hand, curve 306, a risk curve of a diabetic with the same average HbA_{1c} of 9% but a higher Std_HbA_{1c}, hence a higher risk of contracting retinopathy. FIG. 1C also shows the difference in risk 308, which is caused by the variation of Std_HbA_{1c} even when the average HbA_{1c} remains the same.

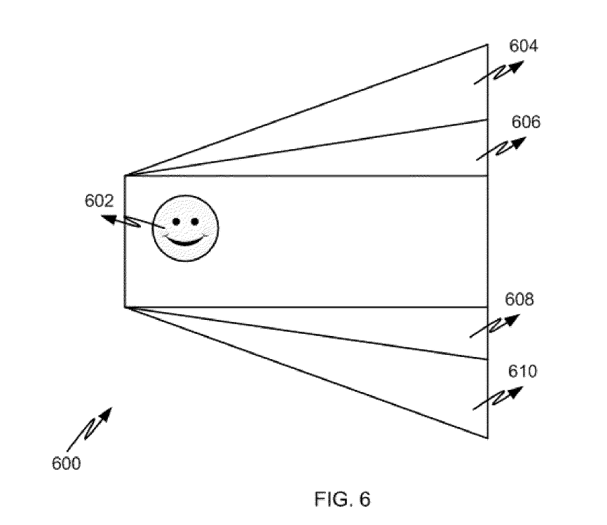

At step 110, the BGCI is displayed to the subject. In an embodiment, the BGCI is displayed using a visual indicator on a display interface. In some embodiments, a severity of BGCI is displayed using different colors. The visual indicator is explained in detail in conjunction with FIG. 6. Based on the visual indication of BGCI, the subject can make appropriate adjustments in the lifestyle to regulate diabetes.

Turning now to FIG. 4, which is a flow diagram of a method for calculating a Severe Hypoglycemia Risk Index (SHRI) based on a plurality of Blood Glucose (BG) data of the subject, in accordance with an embodiment of the invention. In an exemplary embodiment, the SHRI indicates a percentage of BG data that is below 3 mmol/l. It is taken care that the SHRI value is at least 10% of the plurality of BG data having less than 4 mmol/l. In an exemplary scenario, a diabetic subject controls the blood glucose by adjusting insulin dosages, meals, exercises. However, there may be variations in the BG, where the BG values go below 4 mmol/l, due to the effect of certain physiological factors that cannot be controlled. In general, it is acceptable if the BG goes below 4 mmol/l occasionally. However, if the BG data drops below 3 mmol/l, there is a high risk of the subject experiencing severe hypoglycemia. Further, a high value of SHRI indicates that the subject needs to control blood glucose variability, while maintaining optimum HbA_{1c} values.

At step 402, a HbA_{1c} estimate (HbA_{1c—}E) is determined based on the sample BG data. The HbA_{1c—}E is determined as explained in the description of step 102 of FIG. 1A.

At step 404, a percentage of BG data that is below a predefined threshold (LT4) is determined by comparing each BG data of the plurality of BG data with the predefined threshold. In an exemplary implementation, the threshold is 4 mmol/l. In an example, the plurality of BG data includes 100 BG values of which 25 are below 4 mmol/l. As a result, LT4 is calculated as 25% of the plurality of BG data. In some embodiments, the threshold can be changed based on parameters such as, but not limited to, a physiological status, a genetic history, an ethnic group and smoking habits of the subject. The parameter LT4 gives the percentage of low BG data, which indicates the variation of the BG data. A risk of hypoglycemia increases when the parameter LT4 increases.

At step 406, a standard deviation of the BG data (Std_BG) of the subject is determined based on the plurality of BG data. The Std_BG is calculated by first determining a mean BG value of the plurality of BG data. Subsequently, the mean BG value is subtracted from each BG data of the plurality of BG data resulting in mean subtracted plurality of BG data. Thereafter, a square root of the average of mean subtracted plurality of BG data is taken for calculating the Std_BG. Subsequently, at step 408 the SHRI is calculated based on the HbA_{1c—}E, the LT4 and the Std_BG.

In an embodiment, the SHRI can be calculated using a formula as below:

SHRI=A×LT4×Std_BG/HbA_{1c—}E

where A is a numeric value dependent on the characteristics of a group of people that the subject belongs. In an embodiment, the scaling factor A is defined over multiple time periods so that there are accurate estimates regarding the percentages of LT4 and LT3, respectively. In an exemplary embodiment, LT3 is defined as below:

LT3=A×LT4×Std_BG/HbA_{1c—}E

In an exemplary embodiment, scaling factor A is calculated as below:

A=0.1×HbA_{1c—}E/Std_BG

When the parameters LT3, LT4, HbA_{1c—}E and Std_BG values are known, a set of A_d values is also calculated. Thereafter, the best estimate of A for that person is determined by taking the average of the set of values A_d, AVE(set of A_d values).

In an exemplary scenario, an observed LT3 value (LT3_o) may not be equal to 0.1×LT4_o, thus the scaling factor A calculated as below:

A=LT3_{—}o/(0.1×LT4_{—}o)×AVE(set of A_{—}d values)

As an example, a person with BG_STD=3.5, HbA_{1c—}E=7.0, LT4_o=20%, and LT3_o=2%, respectively, has an LT3 value equal to 0.1×LT4. In this duration, scaling factor A has a value of 0.2 calculated as 0.1×7/3.5=0.2. SHRI for the person is given by

SHRI=0.2×LT4×Std_BG/HbA_{1c—}E

In another exemplary case, if the observed LT3_o is 4%, the scaling factor A is 0.4, and SHRI would be two times higher for each set of observations.

At step 410, the SHRI is displayed to the subject. In an embodiment, the SHRI is displayed using a visual indicator on a display interface. In some embodiments, a severity of SHRI is indicated using different colors. The visual indicator is explained in detail in conjunction with FIG. 6. Based on the visual indication of SHRI, subject can make appropriate adjustments in the lifestyle to regulate diabetes.

In an exemplary scenario, the subject can adjust the insulin intake based on the BGCI and SHRI values. The subject can make changes in lifestyle by adjusting one or more of, but not limited to, food intake timings, type of food and an exercise regime, along with the insulin dosage to control the diabetes. For example, the subject may decrease an intake of carbohydrates and increase the duration of physical activity, while keeping the insulin dosage constant to maintain healthy BGCI and SHRI values.

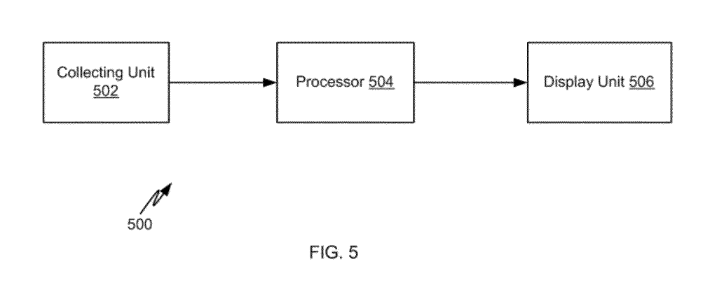

Turning now to FIG. 5 which illustrates a block diagram of a system 500 for calculating a Blood Glucose Control Index (BGCI) and a Severe Hypoglycemia Risk Index (SHRI) based on a plurality of Blood Glucose (BG) data of a subject, in accordance with an embodiment of the invention. As illustrated, system 500 includes a collecting unit 502 configured to collect the plurality of BG data. Further, system 500 includes a processor 504 configured to calculate at least one of the BGCI and the SHRI based on a plurality of Blood BG data of the subject using computer readable instructions configured to calculate at least one of BGCI and SHRI in accordance with the methods disclosed herein.

In an exemplary embodiment, processor 504 includes an adaptive model which is automatically updated to clearly reflect a risk level of the subject. As and when the plurality of BG data accumulates, the adaptive model continuously segregates the plurality of BG data into one or more clusters based on, for example, an ethnic background, a genetic history, smoking habits, age, type of diabetes and body mass index (BMI). Thereafter, statistical analysis is performed on the plurality of BG data in each cluster to verify if each of the one or more clusters is statistically different from one another. Further, accuracy of risk curves associated with the one or more clusters is increased with the accumulation of the plurality of BG data, thereby enabling the subject to have an accurate calculation regarding the risk of secondary complications.

System 500 also includes a display unit 506 configured to show an overall status of diabetes control of the subject which includes the values of BGCI and SHRI. Further, display unit 506 is configured to provide a visual feedback to the subject regarding the quality of BG measurements that are taken.

Referring now to FIG. 6, which illustrates a detailed view of an indicator 600 which is displayed on display unit 506, in accordance with an embodiment of the invention. As shown in FIG. 3B, indicator 600 includes an emoticon 602 for indicating an overall status of diabetes based on the plurality of BG data collected from the subject. In an embodiment, emoticon 602 changes an expression to at least one of, happy, sad and neutral based on a quality of the plurality of BG data collected. For example, emoticon 602 bears a sad expression when the quality of BG measurements is not satisfactory. In an exemplary embodiment, when the subject activates emoticon 602 by at least one of, but not limited to, clicking and touching, the reason for bearing the expression is displayed along with suggestions to improve the quality of measurements. Further, indicator 600 includes BGCI indicators such as, a first level BGCI indicator 604 and a second level BGCI indicator 606. The BGCI indicators indicate the subject with the criticality of the BGCI value. For example, when a BGCI value of the subject is high, first level BGCI indicator 604 is activated. Further, when the BGCI value is critically high, second level BGCI indicator 606 is activated. Furthermore, indicator 600 includes SHRI indicators such as, a first level SHRI indicator 608 and a second level SHRI indicator 610. In an embodiment, SHRI indicators indicate a severity of the SHRI value to the subject. In an exemplary embodiment, different colors can be used to indicate the severity of the BGCI and the SHRI values. In an exemplary scenario, a BGCI value of the subject is high and the SHRI value is critically high. In such a case, the first level BGCI indicator 604 is turned on with a yellow color, indicating a high value of BGCI. Further, first level SHRI indicator 608 and second level SHRI indicator 610 are both turned on, where first level SHRI indicator 608 has a yellow color and second level SHRI indicator 610 has a red color indicating critically high value of SHRI.

Various embodiments of the invention provide methods and systems for calculating indices for diabetes control of the subject. The method and system provides the subject with the BGCI and SHRI which indicate the probability of contracting secondary complications in the future. The method and system also provides visual indications to the subject regarding an overall state of diabetes control. The subject can make appropriate changes in the life style in order to bring diabetes under control. Furthermore, the method and system profiles variations in risk factor across population groups thereby providing an accurate estimation of risk curves associated with the diabetes related secondary complications.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for calculating a Blood Glucose Control Index (BGCI) based on a plurality of Blood Glucose (BG) data of a subject, wherein the plurality of BG data comprises a set of BG data of the subject collected over a first period of time and a sample BG data of the subject collected over a second period of time, wherein the set of BG data is collected prior to the sample BG data, the method comprising:
determining a HbA_{1c} estimate (HbA_{1c—}E) based on the sample BG data;
determining a standard deviation of the HbA_{1c—}E (Std_HbA_{1c—}E) based on the plurality of BG data;
determining an average of high BG data (Avg_high) based on the plurality of BG data;
calculating the BGCI based on the HbA_{1c—}E, the Std_HbA_{1c—}E and the Avg_high; and
providing a visual indication based on the BGCI to the subject, wherein the visual indication is provided on a display unit.

2. The method of claim 1, wherein determining the Avg_high comprises determining the average of the top 10% values of the plurality BG data.

3. The method of claim 1, wherein calculating the BGCI further comprises utilizing
BGCI=A×HbA_{1c}+f₁(Std_HbA_{1c—}E)+f₂(Avg_high);
wherein A is a decimal number and f₁ and f₂ are functions of Std_HbA_{1c—}E and Avg_high, respectively.

4. The method of claim 3, wherein A is determined for a group of subjects based on a probability value associated with diabetes related secondary diseases, wherein the group of subjects comprises individual diabetics with a common property,
wherein the common property comprises at least one of, an ethnic group, smoking habits and a particular genetic history.

5. The method of claim 3, wherein at least one of f₁ and f₂ is determined based on at least one of a type of diabetes and a status of diabetes.

6. The method of claim 3, wherein f₁=B×Std_HbA_{1c—}E, wherein B is defined to provide statistical correlation between recognized risk of diabetes related secondary diseases and the variation of HbA_{1c} Estimate.

7. The method of claim 3, wherein f₂=C×(Avg_high−6 mmol/l), wherein C is defined to provide statistical correlation between recognized risk of diabetes related secondary diseases and the difference between Avg_high and blood glucose level of 6 mmol/l.

8. The method of claim 1, wherein the first period of time is a follow-up period.

9. The method of claim 8, wherein the follow-up period is at least one of 14 days, 15 days, 16 days, 17 days, 18 days, 19 days, 20 days, 21 days, 22 days, 23 days, 24 days, 25 days, 26 days, 27 days, and 28 days.

10. The method of claim 1, wherein each of the plurality of BG data is a Self Monitored Blood Glucose (SMBG) data.

11. A method for calculating a Severe Hypoglycemia Risk Index (SHRI) based on a plurality of Blood Glucose (BG) data of a subject, wherein the plurality of BG data comprises a set of BG data of the subject collected over a first period of time and a sample BG data of the subject collected over a second period of time, wherein the set of BG data is collected prior to the sample BG data, the method comprising:
determining a HbA_{1c} estimate (HbA_{1c—}E) based on the sample BG data;
determining a percentage of low BG data (LT4) by comparing each BG data of the plurality of BG data with a threshold;
determining a standard deviation of the BG data (Std_BG) of the subject based on the plurality of BG data;
calculating the SHRI based on the HbA_{1c—}E, the LT4 and the Std_BG; and
providing a visual indication based on the SHRI to the subject, wherein the visual indication is provided on a display unit.

12. The method of claim 11, wherein the threshold is 4 mmol/l.

13. The method of claim 11, wherein calculating the SHRI further comprises utilizing SHRI=A×LT4×Std_BG/HbA_{1c—}E; wherein A is a scaling factor.

14. The method of claim 13, wherein the scaling factor is determined adaptively for the subject for matching the SHRI to a probability of the BG data of the subject being less than a predetermined value.

15. The method of claim 13, wherein the predetermined value is 3 mmol/l.

16. The method of claim 11, wherein the first period of time is a follow-up period.

17. The method of claim 16, wherein the follow-up period is at least one of 14 days, 15 days, 16 days, 17 days, 18 days, 19 days, 20 days, 21 days, 22 days, 23 days, 24 days, 25 days, 26 days, 27 days, and 28 days.

18. The method of claim 11, wherein each of the plurality of BG data is a Self Monitored Blood Glucose (SMBG) data.

19. A system for calculating a Blood Glucose Control Index (BGCI) based on a plurality of Blood Glucose (BG) data of a subject, wherein the plurality of BG data comprises a set of BG data of the subject collected over a first period of time and a sample BG data of the subject collected over a second period of time, wherein the set of BG data is collected prior to the sample BG data, the system comprising:
a collecting unit configured to collect the plurality of BG data; and
a processor configured to:
determine a HbA_{1c} estimate (HbA_{1c—}E) based on the sample BG data;
determine a standard deviation of the HbA_{1c—}E (Std_HbA_{1c—}E) based on the plurality of BG data;
determine an average of high BG data (Avg_high) based on the set of BG data; and
calculate the BGCI based on the HbA_{1c—}E, the Std_HbA_{1c—}E and the Avg_high; and
a display unit configured to display the BGCI.

20. A system for calculating a Severe Hypoglycemia Risk Index (SHRI) based on a plurality of Blood Glucose (BG) data of a subject, wherein the plurality of BG data comprises a set of BG data of the subject collected over a first period of time and a sample BG data of the subject collected over a second period of time, wherein the set of BG data is collected prior to the sample BG data, the system comprising:
a collecting unit configured to collect the plurality of BG data; and
a processor configured to:
determine a HbA_{1c} estimate (HbA_{1c—}E) based on the sample BG data;
determine a percentage of low BG data (LT4) by comparing each BG data of the plurality of BG data with a threshold;
determine a standard deviation of the BG data (Std_BG) of the subject based on the plurality of BG data;
calculate the SHRI based on the HbA_{1c—}E, the LT4 and the Std_BG; and
a display unit configured to display the SHRI.
